(19) United States
(12) Patent Application Publication
(10) Pub. No.: US 2017/0274932 A1
(43) Pub. Date: Sep. 28, 2017

(54) Control Arm Socket Assembly

(71) Applicant: Federal-Mogul Motorparts Corporation, Southfield, MI (US)

(72) Inventor: Thomas J. Byrnes, JR., St. Charles, MO (US)

(21) Appl. No.: 15/077,164

(22) Filed: Mar. 22, 2016

(51) Int. Cl. B62D 17/00; B60G 15/06; B60G 3/20; B60G 7/00

(52) U.S. Cl. CPC B62D 17/00; B60G 7/008; B60G 15/068; B60G 3/20; B60G 7/005; B60G 2200/4622; B60G 2200/142; B60G 2200/46; B60G 2204/61; B60G 2204/1432; B60G 2204/148

(57) ABSTRACT

The control arm assembly includes a control arm body and a socket assembly for connecting the control arm body with a vehicle frame. The socket assembly includes a housing with an inner bore which extends along a vertical axis between opposite open ends. A stud extends past the open ends and has an axially extending through passage. The stud has a pair of end portions on opposite sides of a ball portion that has a curved outer surface which is in sliding contact with a bearing surface for allowing the control arm body to pivot relative to the stud and the vehicle frame. The through passage is eccentrically located in a radial direction on the stud for translating the control arm body relative to the vehicle frame in response to rotation of the stud relative to the housing to adjust a camber angle of the wheel assembly.

### BACKGROUND OF THE INVENTION

1. Field of the Invention

The present invention is related, generally, to control arms for vehicle suspensions and to altering a camber of a wheel assembly.

2. Related Art

Many automotive vehicles today employ types of suspension systems that are commonly known as MacPherson strut systems or double-wishbone systems. Such systems typically include a lower control arm (also referred to as an “A-arm”) which pivots relative to the vehicle's frame to allow a wheel and tire to move upwardly and downwardly relative to the frame during cornering or in response to encountering an object, such as a pot hole in the road.

One example of a lower control arm 10 for a Macpherson strut type of suspension system is generally shown in FIG. 1. The lower control arm 10 includes a ball joint 12 for connection with a steering knuckle (not shown) of a wheel assembly and a pair of bushings 14, 16 for guiding the pivoting movement of the lower control arm 10 relative to the vehicle's frame (not shown). One of the bushings is a horizontal bushing 14 which is configured to pivot relative to the vehicle frame about a longitudinally extending axis. The other bushing 16 is a vertical bushing which is configured to pivot relative to the vehicle frame about a vertically extending axis.

The lower control arm 10 does not include any mechanism for adjusting a camber angle of the wheel assembly to which it is attached, and therefore, in most vehicles with such control arms, the camber angle of the wheel assembly is fixed (i.e., non-adjustable) or the adjustment mechanism is incorporated into a component of the wheel assembly.

### SUMMARY OF THE INVENTION AND ADVANTAGES

One aspect of the present invention is related to a control arm assembly for a vehicle suspension. The control arm assembly includes a control arm body, a connector for attachment with a wheel assembly and a socket assembly for connecting the control arm body with a vehicle frame. The socket assembly includes a housing with an inner bore which extends along a vertical axis from an open first end to an open second end. A stud extends through the inner bore of the housing past the open first and second ends and has an axially extending through passage for receiving a fastener to connect the stud with the vehicle frame. The stud has a pair of end portions on opposite sides of a ball portion that has a curved outer surface which is in sliding contact with a bearing surface for allowing the housing and the control arm body to pivot relative to the stud and the vehicle frame. The through passage is eccentrically located in a radial direction on the stud for translating the control arm body relative to the vehicle frame in response to rotation of the stud relative to the housing to adjust a camber angle of the wheel assembly.

The control arm assembly is advantageous because the eccentrically located through passage allows very simple and quick adjustment of the camber angle of the wheel assembly by a mechanic during maintenance. The control arm body may also be manufactured at a low cost and offers a very long operative life.

According to another aspect of the present invention, one of the end portions of the stud includes a tool engagement feature for receiving a tool to rotate the stud relative to the housing.

According to yet another aspect of the present invention, the tool engagement feature is at least one flat on an outer surface of the end portion.

According to still another aspect of the present invention, the through passage of the stud is generally circular in shape, and a center of the through passage is spaced radially from a center of the stud.

According to a further aspect of the present invention, the control arm assembly further includes a bearing which is disposed in the open bore of the housing, and the bearing surface is on the bearing.

According to yet a further aspect of the present invention, the control arm assembly further includes a cover plate which is disposed adjacent to the first open end of the housing and traps the bearing and stud in the open bore.

According to still a further aspect of the present invention, the first open end of the housing is deformed to engage the cover plate.

According to another aspect of the present invention, the housing is a separate piece from the control arm body.

Another aspect of the present invention is related to a method of making a control arm assembly. The method includes the step of preparing a housing with an inner bore that extends from a first open end to a second open end. The method proceeds with the step of inserting a stud with a ball portion into the inner bore of the housing such that the stud extends past both of the open ends. The stud has an eccentrically located through passage in a radial direction. The method continues to proceed with the step of inserting the housing into an opening of a control arm body.

According to another aspect of the present invention, the stud has a pair of end portions on opposite sides of the ball portion.

According to yet another aspect of the present invention, at least one of the end portions has a tool engagement feature for receiving a tool to rotate the stud relative to the housing and to adjust a camber angle of a wheel assembly.

Yet another aspect of the present invention is related to a method of adjusting a camber angle of a wheel assembly of a vehicle. The method includes the step of preparing a control arm assembly which includes a connector that is attached with the wheel assembly and a vertical socket assembly. The vertical socket assembly has a stud that extends along a vertical axis. The stud has a ball portion with a curved outer surface that is in sliding contact with a bearing surface for allowing the stud to rotate relative to the housing. The stud also has a through passage which is eccentrically located in a radial direction, and a fastener extends through the through passage to attach the stud with a vehicle frame. The method proceeds with the step of rotating the stud about the vertical axis to translate the control arm body relative to the vehicle frame.

According to another aspect of the present invention, the stud includes at least one tool engagement feature, and the step of rotating the stud about the vertical axis is further defined as engaging a tool with the tool engagement feature and rotating the tool to rotate the stud.

According to yet another aspect of the present invention, the stud includes a pair of end portions on opposite sides of the ball portion, and the at least one tool engagement feature is on at least one of the end portions.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective view of one known type of control arm assembly;

FIG. 2 is a perspective view of an exemplary embodiment of an improved control arm assembly constructed according to one aspect of the present invention;

FIG. 3 is a perspective view showing the control arm assembly of FIG. 2 as a component of a MacPherson strut style of suspension assembly of a vehicle and with a wheel assembly having one camber angle;

FIG. 4 is another perspective view showing the control arm assembly of FIG. 2 as a component of a MacPherson strut style of suspension assembly of a vehicle and with the wheel assembly having a different camber angle from FIG. 3;

FIG. 5 is a cross-sectional view of a socket assembly of the control arm assembly of FIG. 2;

FIG. 6 is a top elevation view of the socket assembly of FIG. 5;

FIG. 7 is a cross-sectional view of the control arm assembly of FIG. 2 as connected with a vehicle frame and with the control arm body with the stud being in one rotational position to give a wheel assembly a first camber angle;

FIG. 8 is another cross-sectional view of the control arm assembly of FIG. 2 as connected with a vehicle frame and with the stud being in a different rotational orientation than FIG. 7 to give a wheel assembly a different camber angle

FIG. 9 is another cross-sectional view of the control arm assembly of FIG. 2 as connected with a vehicle frame and with the control arm body being in a different orientation than FIG. 7;

FIG. 10 is yet another cross-sectional view of the control arm assembly of FIG. 2 as connected with a vehicle frame and with the control arm body being in a different orientation than FIGS. 7 and 9; and

FIG. 11 is another top elevation view of the socket assembly of FIG. 5 and showing a tool in engagement with a tool engagement feature on a stud for rotating the stud.

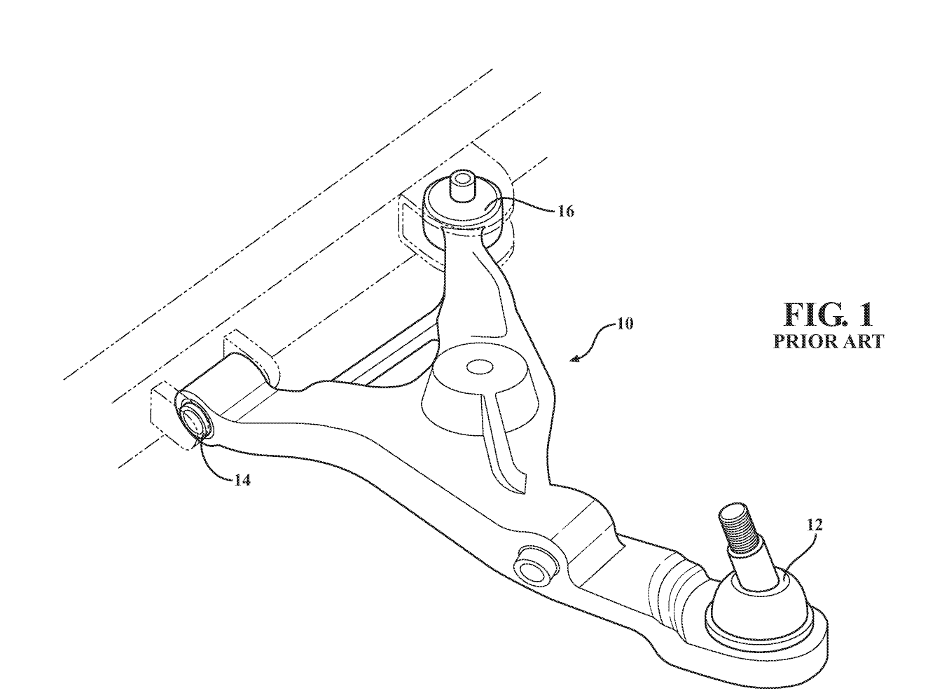

### DESCRIPTION OF THE ENABLING EMBODIMENT

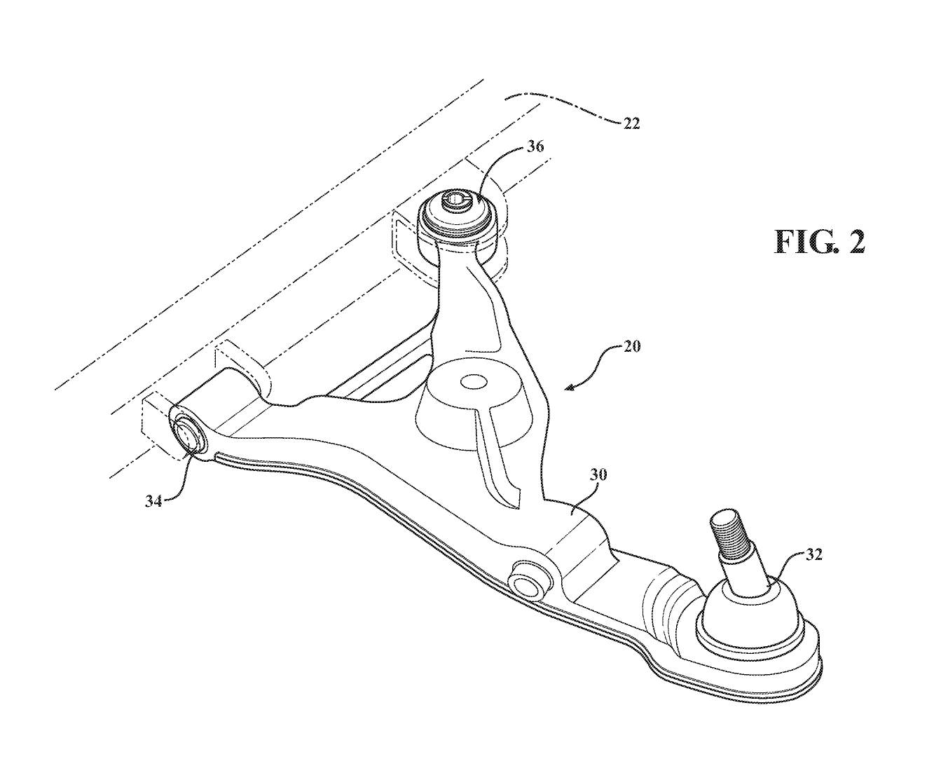

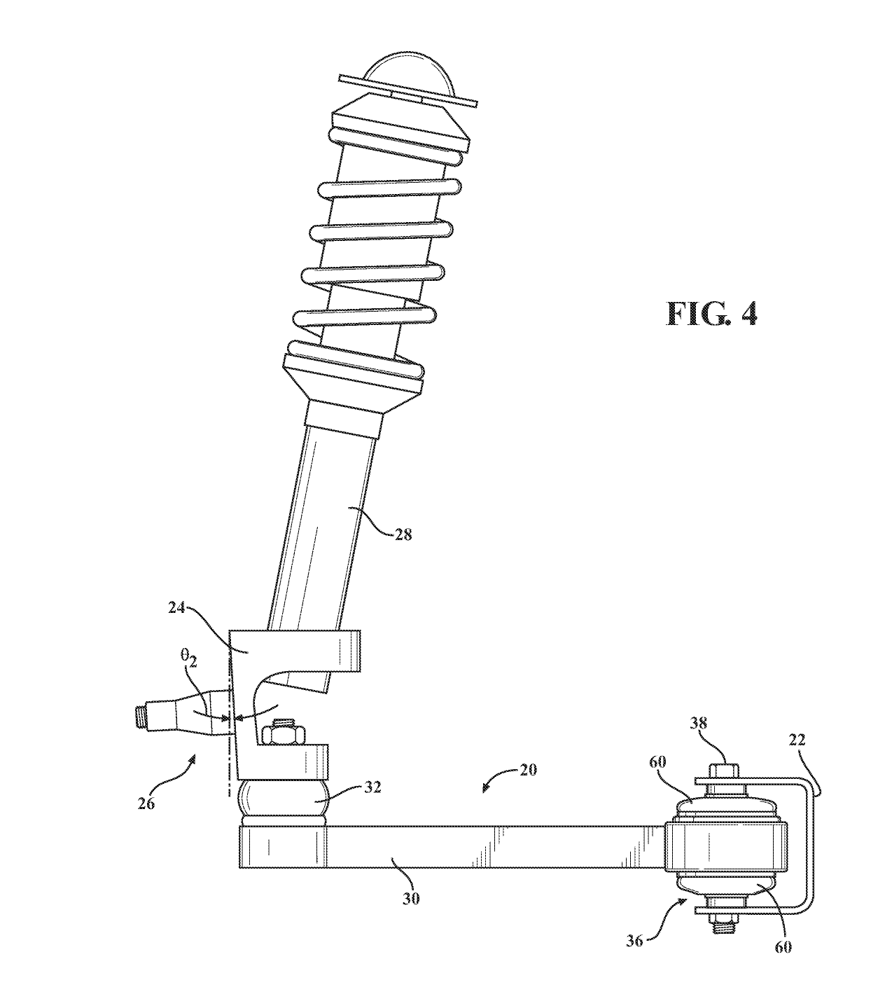

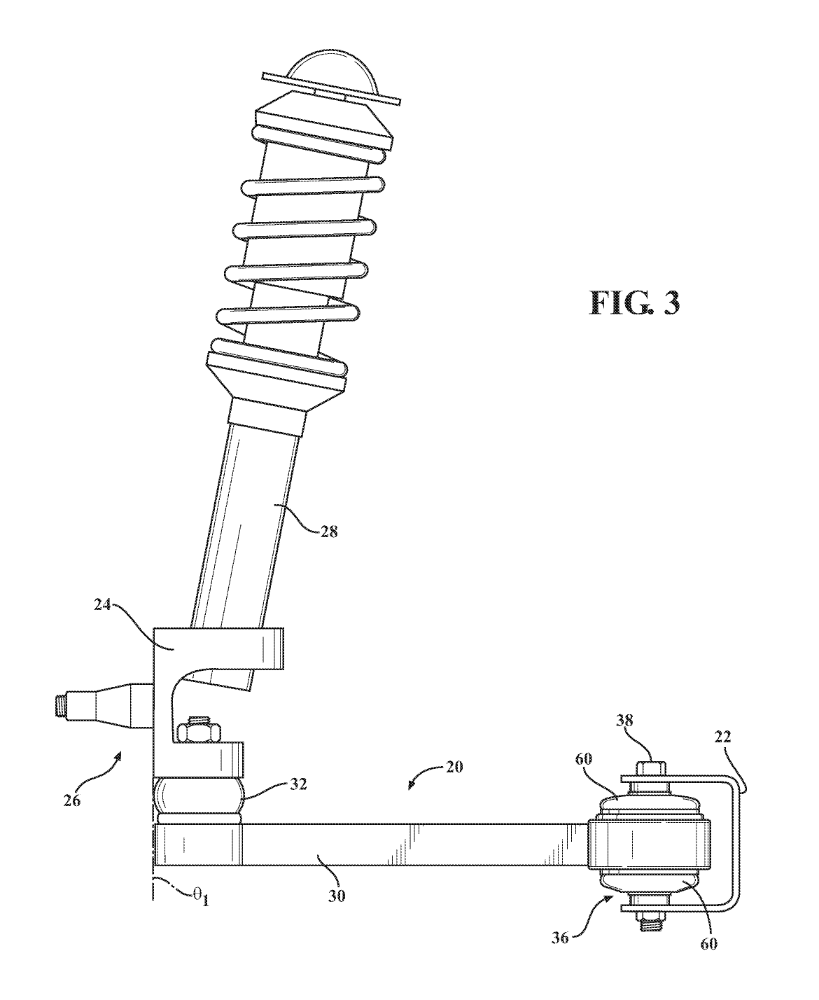

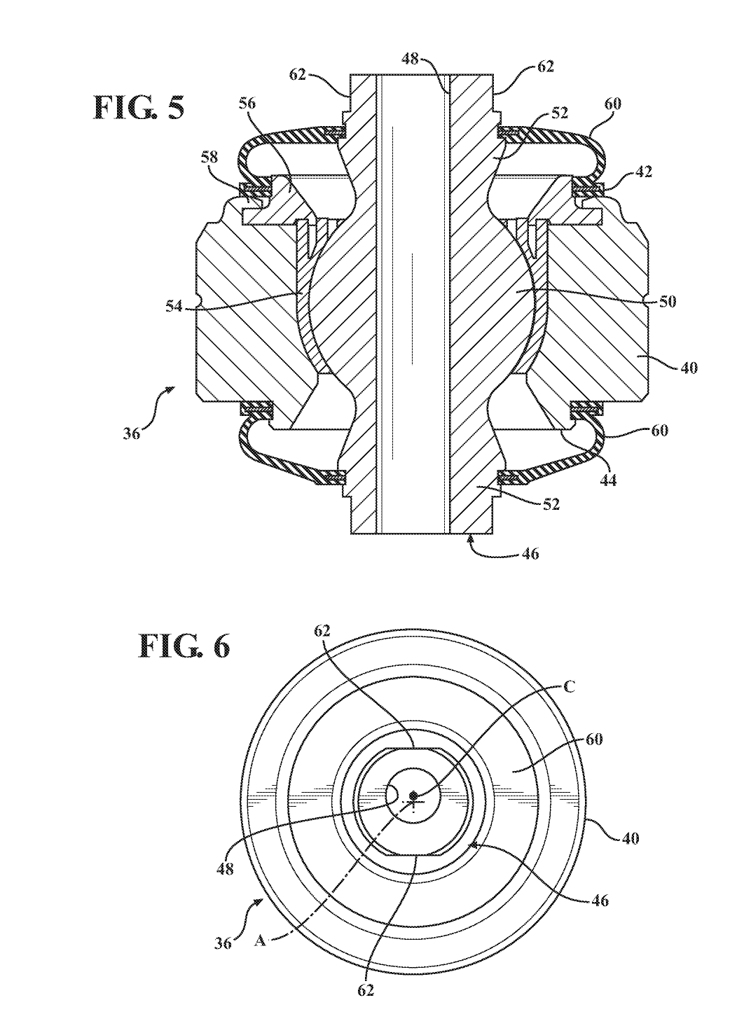

Referring to the Figures, wherein like numerals indicate corresponding parts throughout the several views, a first exemplary embodiment of an improved control arm assembly 20 for adjusting a camber angle of a wheel assembly is generally shown in FIG. 2. In FIGS. 3 and 4, the control arm assembly 20 is used in conjunction with a MacPherson strut style of suspension system. Specifically, in FIGS. 3 and 4, the control arm assembly 20 interconnects a vehicle frame 22 (which could be a unibody in some many vehicles) with a knuckle 24 of the wheel assembly 26, and a strut 28 with a coil spring and a shock absorber interconnects the knuckle 24 with another location on the vehicle frame 22. However, it should be appreciated that the control arm assembly 20 could find uses in double-wishbone suspension systems or any other suitable types of suspension systems.

The exemplary embodiment of the control arm assembly 20 includes a generally wishbone-shaped control arm body 30 which is made as one integral piece of metal. A connector (such as a ball joint 32) is located at one end of the control arm body 30 for connecting the control arm body 30 with the knuckle 24 of the wheel assembly 26. Opposite of the ball joint 32, the control arm assembly 20 further includes a horizontal bushing 34 which is attachable with the vehicle frame 22 via a horizontally extending bolt (or any suitable fastener).

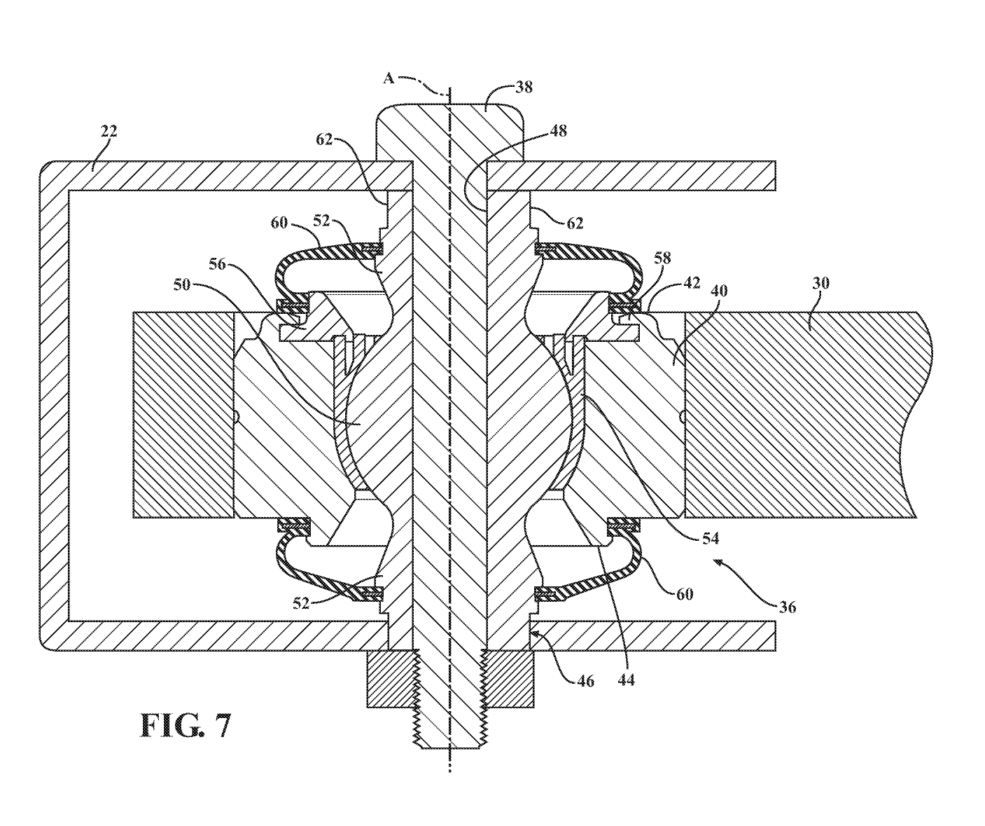

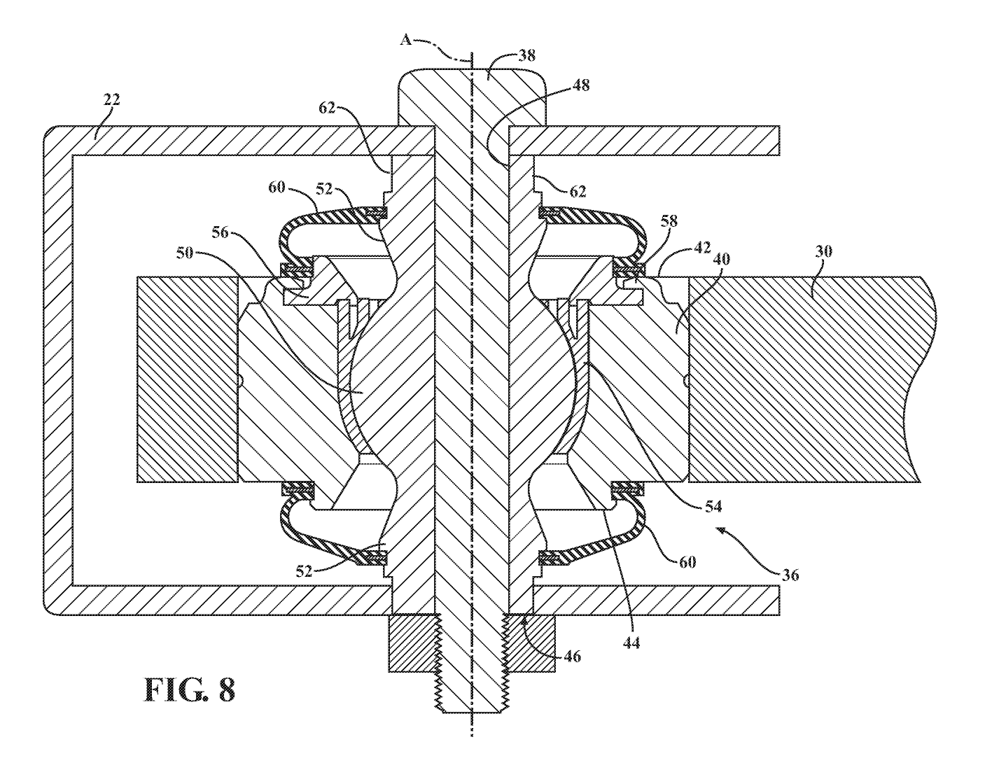

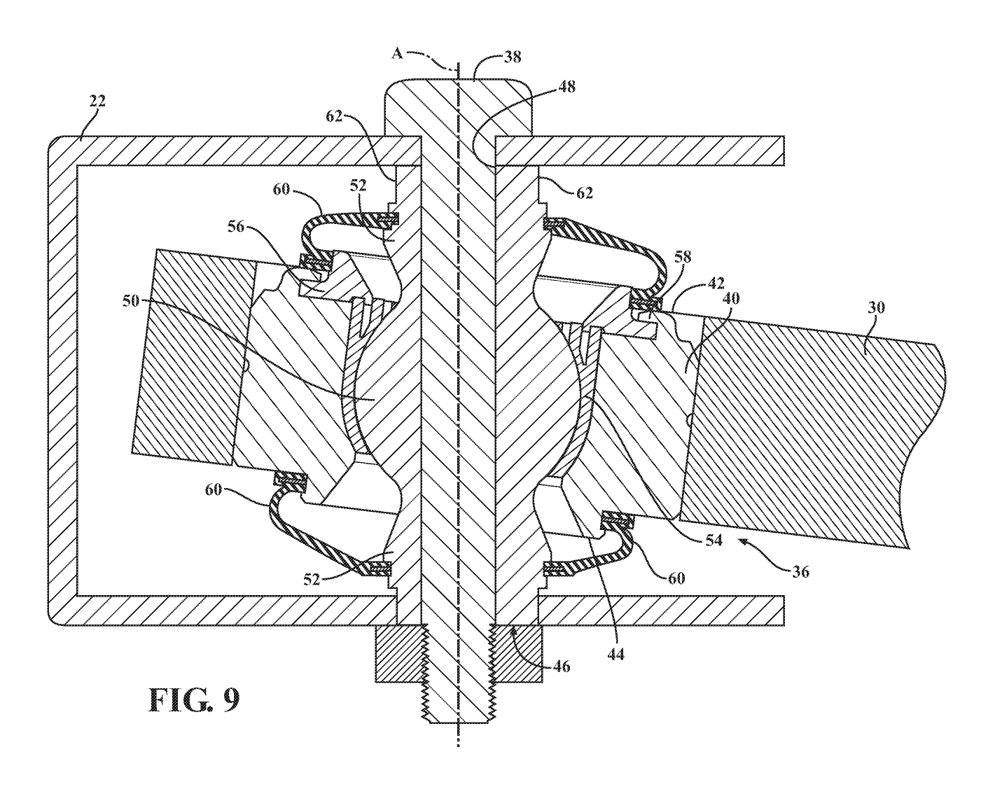

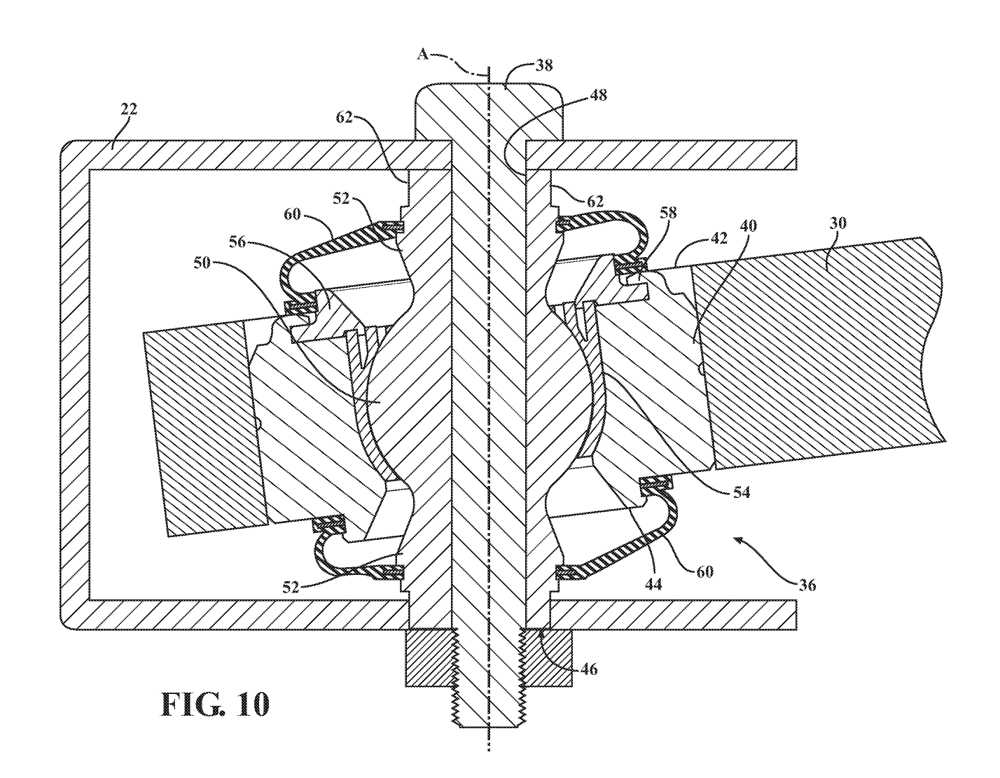

The control arm assembly 20 also includes a vertical socket assembly 36 for connecting the control arm body 30 with the vehicle frame 22 via a vertically extending bolt 38 (or any suitable fastener). As shown in FIGS. 7-10, during operation of the vehicle, the vertical socket assembly 36 and the horizontal bushing 34 (shown in FIG. 2) allow the control arm body 30 to rotate or pivot relative to the vehicle frame 22 when, for example, the wheel assembly 26 (shown in FIGS. 3 and 4) encounters a pot hole or an obstacle in the road to maintain the wheel assembly 26 in contact with the road and to provide a more comfortable ride for passengers in the vehicle.

Referring still to FIGS. 7-9, the exemplary embodiment of the vertical socket assembly 36 includes a housing 40 which is press-fit into an opening in the control arm body 30. The housing 40 has an inner bore which extends along a vertical axis between an open first (or upper, with reference to the orientation of the socket assembly in these Figures) end 42 and an open second (or lower) end 44. The vertical socket assembly 36 also includes a stud 46 which extends through the inner bore and past the open first and second ends 42, 44 of the housing 40. The stud 46 has a through passage 48, and a bolt 38 (or any suitable type of fastener) extends through the through passage 48 to interconnect the stud 46 with the vehicle frame 22. The stud 46 may be made of any suitable material including, for example, a heat treated SAE alloy steel.

The exemplary embodiment of the stud 46 includes a rounded central or ball portion 50 with a generally spherically curved outer surface and a pair of end portions 52 on opposite sides of the ball portion 50. The socket assembly 36 further includes a bearing 54 which is located in the inner bore of the housing 40 and which has a spherically curved bearing surface in sliding contact with the curved outer surface of the ball portion 50 of the stud 46 to permit the bearing 54 and housing 40 to rotate relative to the stud 46 and vehicle frame 22 during operation of the vehicle. The exemplary bearing 54 is a one-piece snap over bearing 54 with a plurality of circumferentially spaced slots for allowing the bearing 54 to flex to snap into engagement with the ball portion 50 of the stud 46 during assembly and thereby engage both an upper hemisphere and a lower hemisphere of the ball portion 50. However, it should be appreciated that other designs of the bearing could be employed. The bearing 54 may be made of a metal, a carbon fiber polymer, an engineering polymer or any suitable material that provides a low friction interface between the stud 46 and the bearing 54. Grease, or any suitable lubricant, may also be injected into the inner bore of the housing 40 to further reduce friction between the stud 46 and the bearing 54, thereby improving the operating life of the socket assembly 36.

A cover plate 56 is disposed adjacent the first open end 42 of the housing 40 to retain the bearing 54 and the stud 46 within the inner bore of the housing 40. A lip 58 at the first open end 42 of the housing 40 is bent radially (e.g., through swaging) inwardly to trap the cover plate 56 within the inner bore of the housing 40. However, it should be appreciated that the cover plate could be connected with the housing through any suitable means.

The socket assembly 36 further includes a pair of dust boots 60 which are sealed against the housing 40 and against the stud 46 to maintain a lubricant within the interior of the socket assembly 36 and to keep contaminants out of the interior of the socket assembly 36. The seals between the dust boots 60 and the stud 46 are spaced from the axial ends of the stud 46. That is, the end portions 52 of the stud 46 extend axially past the ends of the dust boots 60. The dust boots 60 may be sealed against the housing 40 and the stud 46 through any suitable means.

The socket assembly 36 is configured for quickly and easily adjusting the camber angle of the wheel assembly simply by rotating the stud 46 relative to the housing 40. For example, FIG. 3 the wheel assembly 26 as having a first camber angle θ₁ which is approximately zero, and FIG. 4 shows the wheel assembly 26 as having a second camber angle θ₂ which is negative. With reference to FIG. 6, this adjustability is possible because the through passage 48 of the stud 46 is eccentrically located within the stud 46. Specifically, the through passage 48 is generally circular in shape when viewed in cross-section, and a center C of the circular through passage 48 is spaced radially from a central axis A which extends through the stud 46. In the exemplary embodiment, the through passage 48 has a diameter of approximately 0.375 inches, and the center C of the through passage 48 is spaced from the central axis A of the stud 46 by approximately 0.05 inches. As such, the wall thickness of the stud 46 varies around the through passage 48. The sliding connection between the semi-spherically curved outer surface of the stud 46 and the semi-spherically curved bearing surface of the bearing 54 allow for rotation of the stud 46 relative to the bearing 54.

The stud 46 is rotatable from a first orientation (shown in FIGS. 3 and 7) to give the wheel assembly 26 the first camber angle θ₁ to a second orientation (shown in FIGS. 4 and 8) to give the wheel assembly 26 the second camber angle θ₂ which is more negative than the first camber angle θ₁. Rotation of the stud 46 relative to the housing 40 has the effect of translating the control arm body 30 relative to the vehicle frame 22, which adjusts the orientation of the knuckle 24 of the wheel assembly 26. The first and second orientations are approximately one hundred and eighty degrees (180°) apart from one another. That is, one half of a turn of the stud 46 relative to the housing 40 changes the camber angle θ from one extreme to an opposite extreme.

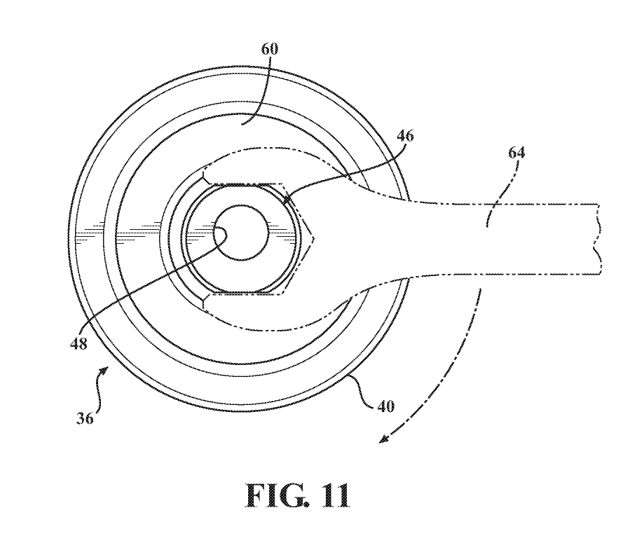

The stud 46 includes at least one tool engagement feature 62 for rotating the stud to adjust the camber angle θ of the wheel assembly 26. In the exemplary embodiment, the tool engagement feature 62 is a pair of diametrically opposed flats 62 on one of the end portions 52 of the stud outside of the dust boot 60 for receiving a tool, such as a wrench 64 (shown in FIG. 11), to rotate the stud 46 relative to the housing 40.

Another aspect of the present invention is related to a method of making a control arm assembly 20. The method includes the step of preparing a housing 40 with an inner bore that extends from a first open end 42 to a second open end 44. The method proceeds with the step of inserting a stud 46, which has a ball portion 50 and a pair of end portions 52, into the inner bore of the housing 40 such that the stud 46 extends past both of the open ends 42, 44. At least one of the end portions 52 has a tool engagement feature 62 for receiving a tool to rotate the stud 46 relative to the housing. The stud 46 has an eccentrically located through passage 48 for adjusting a camber angle of a wheel assembly by rotating the stud 46 relative to the housing 40. The method continues with the step of inserting the housing 40 into an opening of a control arm body 30.

Yet another aspect of the present invention is related to a method of adjusting a camber angle of a wheel assembly 26 in a vehicle. The method continues with the step of preparing a control arm assembly 20 which includes a connector (such as a ball joint 32) that is attached with a wheel assembly 26. The control arm assembly 20 further includes a vertical socket assembly 36 with a stud 46 that extends along a vertical axis A. The stud 46 has a ball portion 50 with a curved outer surface that is in sliding contact with a bearing surface for allowing the stud 46 to rotate relative to the housing 40. The stud 46 has a through passage 48 which is eccentrically located in a radial direction. A fastener 38 extends through the through passage 48 to attach the stud 46 with a vehicle frame 22. The method proceeds with the step of rotating the stud 46 about the vertical axis A to translate the control arm body 30 relative to the vehicle frame 22.

Preferably, the stud 46 includes at least one tool engagement feature 62 and the step of rotating the stud 46 relative to the housing 40 is further defined as engaging a tool 64 with the tool engagement feature 62 and rotating the tool 64 to rotate the stud 46. The tool engagement feature 62 is at least one flat on at least one of the end portions 52 of the stud 46.

Obviously, many modifications and variations of the present invention are possible in light of the above teachings and may be practiced otherwise than as specifically described while within the scope of the appended claims.

What is claimed is:

1. A control arm assembly for a vehicle suspension, comprising:
a control arm body, a connector for attachment with a wheel assembly, and a socket assembly connecting said control arm body with a vehicle frame;
said socket assembly including a housing with an inner bore which extends along a vertical axis from an open first end to an open second end;
a stud extending through said inner bore of said housing past said open first and second ends and having an axially extending through passage for receiving a fastener to connect said stud with the vehicle frame;
said stud having a pair of end portions on opposite sides of a ball portion that has a curved outer surface which is in sliding contact with a bearing surface for allowing said housing and said control arm body to pivot relative to said stud and to the vehicle frame; and
said through passage being eccentrically located in a radial direction on said stud for translating said control arm body relative to the vehicle frame in response to rotation of said stud relative to said housing to adjust a camber angle of the wheel assembly.

2. The control arm assembly as set forth in claim 1 wherein at least one of said end portions of said stud includes a tool engagement feature for receiving a tool to rotate said stud relative to said housing.

3. The control arm assembly as set forth in claim 2 wherein said tool engagement feature is at least one flat on an outer surface of said end portion.

4. The control arm assembly as set forth in claim 1 wherein said through passage of said stud is generally circular in shape and wherein a center of said through passage is spaced radially from a center of said stud.

5. The control arm assembly as set forth in claim 1 further including a bearing disposed within said open bore of said housing and wherein said bearing surface is on said bearing.

6. The control arm assembly as set forth in claim 4 further including a cover plate adjacent said first open end of said housing and trapping said bearing in said open bore.

7. The control arm assembly as set forth in claim 5 wherein said first open end of said housing is deformed to engage said cover plate.

8. The control arm assembly as set forth in claim 1 wherein said housing is a separate piece from said control arm body.

9. A method of making a control arm assembly, comprising the steps of:
preparing a housing with an inner bore that extends from a first open end to a second open end;
inserting a stud with a ball portion into the inner bore of the housing, the stud extending past both of the open ends, and the stud having an eccentrically located through passage in a radial direction; and
inserting the housing into an opening of a control arm body.

10. The method as set forth in claim 1 wherein the stud has a pair of end portions on opposite sides of the ball portion.

11. The method as set forth in claim 10 wherein at least one of the end portions has a tool engagement feature for receiving a tool to rotate the stud relative to the housing and adjust a camber angle of a wheel assembly.

12. A method of adjusting a camber angle of a wheel assembly of a vehicle, comprising the steps of:
preparing a control arm assembly including a connector that is attached with the wheel assembly and a vertical socket assembly, the vertical socket assembly having a stud that extends along a vertical axis, the stud having a ball portion with a curved outer surface that is in sliding contact with a bearing surface for allowing the stud to rotate relative to the housing, the stud having a through passage which is eccentrically located in a radial direction, a fastener extending through the through passage to attach the stud with a vehicle frame; and
rotating the stud about the vertical axis to translate the control arm body relative to the vehicle frame.

13. The method as set forth in claim 12 wherein the stud includes at least one tool engagement feature and wherein the step of rotating the stud about the vertical axis is further defined as engaging a tool with the tool engagement feature and rotating the tool to rotate the stud.

14. The method as set forth in claim 13 wherein the at least one tool engagement feature is further defined as at least one flat on the stud.

15. The method as set forth in claim 13 wherein the stud includes a pair of end portions on opposite sides of the ball portion and wherein the at least one tool engagement feature is on at least one of the end portions.
